(19) United States
(12) Patent Application Publication
(10) Pub. No.: US 2012/0120039 A1
(43) Pub. Date: May 17, 2012

(54) Driving System for Display and Method of the Same

(75) Inventors: Ying-Chung SU, Tainan City (TW); Jhen-Shen Liao, Bade City (TW); Hung-Hsiang Chen, Zhongli City (TW)

(73) Assignee: CHUNGHWA PICTURE TUBES, LTD., Bade City (TW)

(21) Appl. No.: 13/075,198

(22) Filed: Mar. 30, 2011

(30) Foreign Application Priority Data
Nov. 16, 2010 (TW) 099139433

(51) Int. Cl. G06F 3/038

(52) U.S. Cl. 345/208

(57) ABSTRACT

The present invention discloses a driving system and the method thereof for a display system, and particularly for the display system with a bi-stable display. The driving system of the present invention has the advantage of requiring less memory capacity than that of traditional driving systems. The driving system of the present invention reads one frame data at one time and will clear the current frame before displaying a new frame. Owing to the current frame being cleared before a new frame being updated, the driving system needs not to record the difference of gray level between the two frames and thereby reduces the requirement of memory capacity.

### CROSS REFERENCE TO RELATED APPLICATION

This present application claims priority to TAIWAN Patent Application Serial Number 099139433, filed on Nov. 16, 2010, which are herein incorporated by reference.

### TECHNICAL FIELD

The present invention relates to a display driving system, and particularly to a driving system and a driving method for an electronic paper display system.

### BACKGROUND OF THE RELATED ART

Nowadays, electronic papers are more and more popular. With respect to the traditional electronic paper (hereinafter called E-paper), as shown in FIG. 1, an electronic paper includes a memory system 111 112, a waveform output unit 120 and a bi-stable display 130. In general, when traditional E-papers 10 would like to update a new frame, they need to compare the data of the new frame with the current frame. Therefore, the prior art of an E-paper 10 requires larger memory capacity to store at least two frame data, the current and the new frame.

For one example, as shown in FIG. 1, the traditional display driving system for E-papers includes memory_1 111 to store the current frame data and memory_2 112 to store the new frame data. The waveform output unit 120 reads the data from both memory_1 111 and memory_2 112 and compares the difference of the gray level of each pixel between two frames. According to a look-up table (LUT) 122, in which each of different output conditions is mapped onto each of different gray levels, the waveform output unit 120 will send out the respective control signal for each pixel to show a new frame on a bi-stable display 130.

Given that a frame has N gray levels, the waveform output unit 120 needs to store N×N output conditions in the look-up table (LUT), as shown in FIG. 2. While the traditional E-paper would like to show a new frame, the comparison unit 121, as shown in FIG. 1, will compare the gray level of each pixel between the current frame and the new frame and map each of the compared results onto each of output conditions in the look-up table (LUT) 122. After that the waveform output unit 120 transmits the respective control signal to each pixel in the bi-stable display 130 in accordance with the output condition of each pixel in the look-up table (LUT) 122. Hence, provided that the number of gray level in a frame is doubled (i.e., 2N), the storage space in the waveform output unit 120 will become 4 times because the look-up table (LUT) 122 needs to store 2N×2N output conditions. Obviously, the storage space in the waveform output unit 120, i.e., memory cost, will become unacceptable huge if the resolution of an E-paper increase rapidly due to the market demand.

Therefore, the prior art of an E-paper 10 not only needs larger memory to store at least two frame data, but requires larger storage space to store N×N output conditions in the look-up table (LUT) 122. Nevertheless, the driving system of the present invention needs to store no more than one frame data and to keep lesser output conditions (i.e., 2N), and consequently the memory capacity of the driving system of the present invention can be reduced tremendously.

### SUMMARY

The present invention discloses a driving system for display, and the system needs less memory capacity than the prior art. The driving system of the present invention includes: A frame data input unit for inputting a frame data, a storage device storing the frame data in sequence from the frame data input unit, a waveform generation unit receiving the frame date from the storage device, wherein the waveform generation unit further comprises a look-up table (LUT) selector and a LUT output unit. After receiving the frame data from the storage device, the waveform generation unit, via the LUT selector, informs the LUT output unit of outputting a control signal. The driving system further includes a display unit receiving the control signal from the LUT output unit and displaying a frame corresponding to the frame data on the display unit.

The storage device includes the storage device include DRAM, SRAM, Flash memory, and the other storage devices being capable of reading the frame data successively and/or randomly from the frame data input unit. One of the improvements of the present invention is that the capacity of the storage device can be reduced to a critical capacity less than the size of storing two frame data, even not more than the size of storing one frame in a good design.

The LUT output unit in the waveform generation unit further includes a displaying LUT output device and a clearing LUT output device, wherein the displaying LUT output device and the clearing LUT output device are electrically coupled to the display unit and output the control signal corresponding to the frame data to the display unit. The displaying LUT output device sends out the control signal to show a frame corresponding to the frame data on the display unit, and the clearing LUT output device sends out the control signal to clear a current frame on the display unit. In the condition that a frame with N gray levels, the displaying LUT output device only needs to store N displaying output conditions and the clearing LUT output device only needs to store N clearing output conditions.

In one embodiment, the display unit of the present invention includes a symmetric bi-stable display, which substantially has symmetric characteristic, so that the LUT output unit is replaced by a flip flop device and the LUT selector is simplified to be a LUT unit. Hence, the waveform generation unit includes a LUT unit and a flip flop device. The flip flop device can output a clearing control signal or a displaying control signal to clear or show the frame, respectively, on the symmetric bi-stable display. Besides, the displaying control signal and the clearing control signal are substantially symmetric and complementary. Both the displaying control signal and the clearing control signal include a DC voltage or a switching waveform with equivalent DC voltage. The duration of an active state of the DC voltage or the equivalent DC voltage is manipulated to control the gray levels of the display. In the condition that a frame with N gray levels, the LUT unit only needs to store N output conditions.

In one embodiment, a position DC voltage or a positive equivalent DC voltage (hereinafter called a first voltage) and a negative DC voltage or a negative equivalent DC voltage (hereinafter called a second voltage) are employed to control the gray levels. The longer duration of the first voltage is, the more darkness of the display unit shows, and the shorter duration of the first voltage is, the more brightness of the display unit shows. On the contrary, the longer duration of the second voltage is, the more brightness of the display unit shows, and the shorter duration of the first voltage is, the more darkness of the display unit shows. The relationship between the voltage vales and the darkness or brightness of the display depends on the characteristic of the display. In another embodiment, it can be that the longer duration of the first voltage is, the more brightness of the display unit shows, and whereas the longer duration of the second voltage is, the more darkness of the display unit shows

The present invention further discloses a method of driving a display. The method applied on the above-mentioned driving system includes: When the display unit would like to update a new frame, the waveform generation unit first reads the frame data of a current frame from the storage device. Thereupon the waveform generation unit, via the LUT selector, informs the LUT output unit of outputting the control signal to clear the current frame on the display unit. After reading a new frame data from the frame data input unit, the storage device sends the new frame data to the waveform generation unit. The LUT selector informs the LUT output unit of sending the control signal to update the new frame on the display unit.

In one embodiment, the method applied on the above-mentioned driving system includes: When the symmetric bi-stable display would like to update a new frame, the waveform generation unit first reads the frame data of a current frame from the storage device. Thereupon the LUT unit informs the flip flop device of outputting the control signal to clear the current frame on the symmetric bi-stable display. After reading a new frame data from the frame data input unit, the storage device sends the new frame data to the waveform generation unit. The LUT unit informs the flip flop device of sending the control signal to update the new frame on the symmetric bi-stable display.

The storage device in the embodiment can be reduced to a critical capacity less than the size of storing two frame data, even not more than the size of storing one frame in a well design. Furthermore, provide that a frame with N gray levels, the output conditions in the LUT unit is reduce to N instead of 2N.

### BRIEF DESCRIPTION OF THE DRAWINGS

The above objects, and other features and advantages of the present invention will become more apparent after reading the following detailed description when taken in conjunction with the drawings, in which:

FIG. 1 illustrates the prior art of driving system for E-paper.

FIG. 2 illustrates the prior art will need to store N×N output conditions, if a frame has N gray levels.

FIG. 3 illustrates the driving system architecture of the present invention.

FIG. 4(a) illustrates the driving system of present invention only needs to store N clearing output conditions, if a frame has N gray levels.

FIG. 4(b) illustrates the driving system of present invention only needs to store N displaying output conditions, if a frame has N gray levels.

FIG. 5(a) illustrates the displaying control signals for a bi-stable display.

FIG. 5(b) illustrates the clearing control signals for a bi-stable display.

FIG. 6 illustrates switching waveforms used to be output control signals.

FIG. 7 illustrates a driving system architecture of the present invention includes a symmetric bi-stable display.

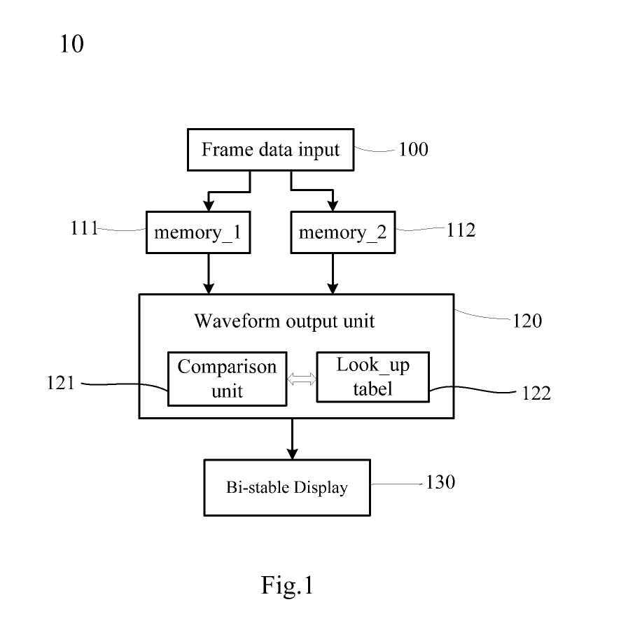

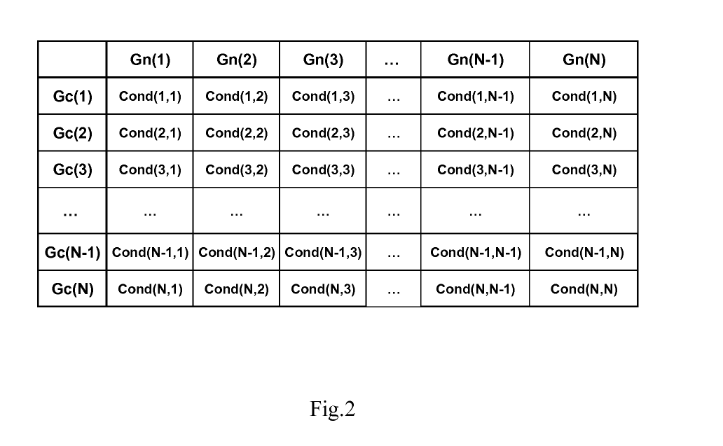

### DETAILED DESCRIPTION

The present invention will be described in detail by using the following embodiments and it will be recognized that those descriptions and examples of embodiments are used to illustrate but not to limit the claims of the present invention. Hence, other than the embodiments described in the following, the present invention may be applied to the other substantially equivalent embodiments.

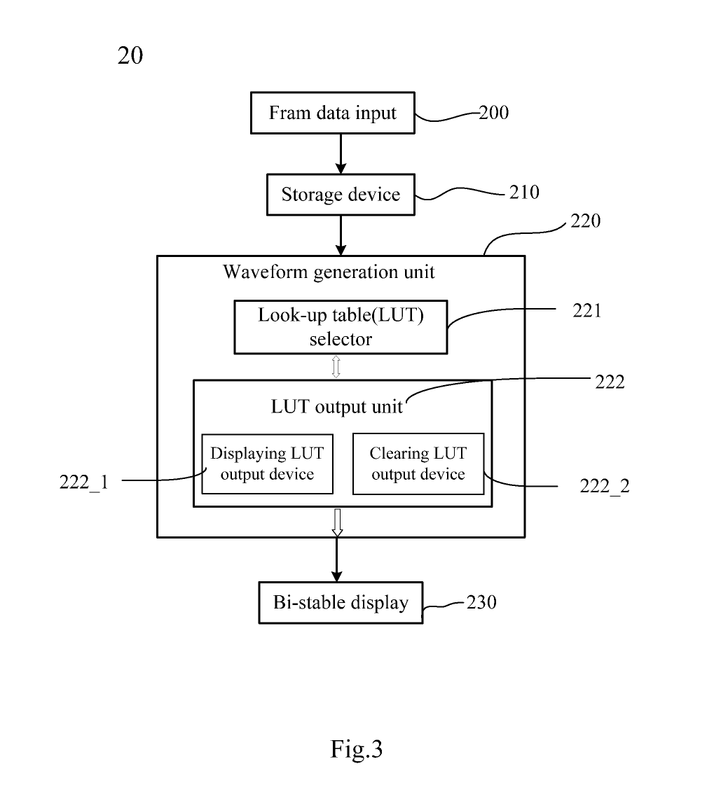

The present invention discloses a driving system for display, and particularly for an electronic paper (E-paper), hereinafter called E-paper, system or the other display systems containing bi-stable display. As shown in FIG. 3, the driving system of the present invention includes a frame data input 200 used to input frame data, a storage device 210 used to the store frame data from the frame data input 200. In one embodiment, the storage device 210 includes dynamic random access memory (DRAM), static random access memory (SRAM), flash memory, hard disk, or the other storage devices which can be stored/read data successively and randomly. The storage device 210 can read frame data from the frame data input 200 successively or randomly, and certainly the larger the size of the storage device 210 has, the more frame data can be stored. Nevertheless, one of improvements of the present invention is that the required memory size of the present invention is much less than that of the prior art. In one embodiment, the memory capacity of the driving system 20 of the present invention can be reduced to a critical size to store the data of less than two frames. In one embodiment, due to a well design, the critical size of the memory can be reduced to store only one or no more than one frame data.

As shown in FIG. 3, a waveform generation unit 220, which includes a look-up table (LUT), hereinafter called LUT, selector 221 and a LUT output unit 222, reads frame data from a storage device 210, and then outputs control signals to a bi-stable display 230 after the comparison processing of frame data is accomplished internally.

In one embodiment, the LUT output unit 222 includes a displaying LUT output device 222_1 and a clearing LUT output device 222_2. The LUT output unit 222 issues displaying control signals from the displaying LUT output device 222_1 to the bi-stable display 230 for updating a new frame or issues clearing control signals from the clearing LUT output device 222_2 to the bi-stable display 230 for clearing a current frame.

In one embodiment, provided that the bi-stable display 230 is showing a current frame, wherein the data of the current frame is kept in the storage device 210 concurrently. Provided that the driving system 20 would like to update a new frame, before the storage device 210 reads the new frame data from the frame data input 200, the waveform generation unit 220 first reads the current frame data from the storage device 210 and the LUT selector 221 selects the clearing LUT output device 222_2 to send out clear signals to clear the current frame on the bi-stable display 230 after the right clearing output condition generated from the clearing LUT output device 222_2 is selected. After that the new frame data is read from the frame data input 200 into the storage device 210 and is sent to the waveform generation unit 220. In the meantime, the LUT selector 221 selects the displaying LUT output device 222_1 to send out display signals to update the new frame on the bi-stable display 230 after the right displaying output condition generated from the displaying LUT output device 222_1 is selected.

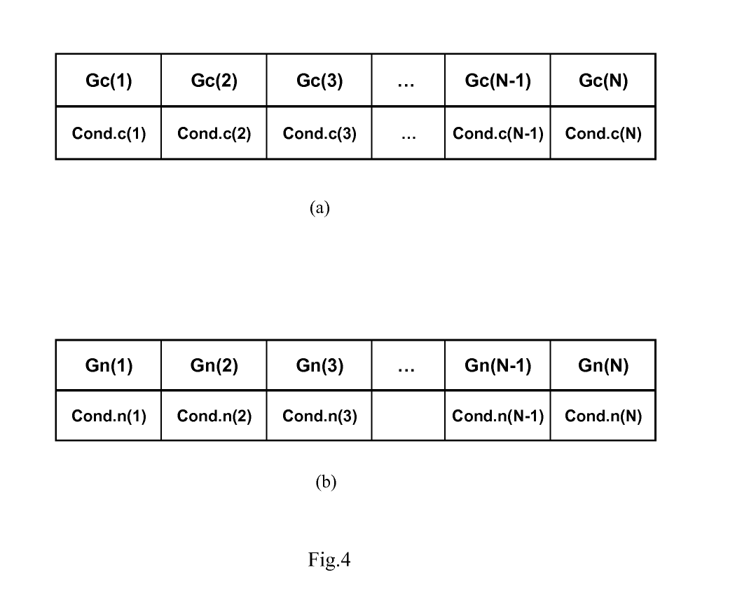

In one embodiment, given that the current frame has N gray levels, it will need to store N clearing output conditions (Cond._{c(1)}˜Cond._{c(N)}) in the clearing LUT output device 222_2, as exemplified in FIG. 4(a). Similarly, as exemplified in FIG. 4(b), provided that a new frame has N gray levels as well, it only needs N displaying output conditions (Cond.ₙ₍₁₎˜Cond._{n(N)}), which map onto respective displaying control signals to the bi-stable display 230, being stored in the displaying LUT output device 222_1 because the current frame is cleared already. Accordingly, the LUT output unit 222 only needs to keep 2N output conditions so that not only the storage space in the waveform generation unit can save with a large amount but the operation speed of the waveform generation unit 220 can increase because of the output conditions in the LUT output unit 222 being decreased with a large amount. The storage space for storing 2N output conditions is not limited to be in the LUT output unit 222. In one embodiment, the above-mentioned storage space can be in the LUT selector 221 or be distributed in the waveform generation unit 220.

The bi-stable display 230 used in the driving system 20 has two stable states and has the characteristics that if the longer duration of a first voltage is applied to the bi-stable display 230, the more darkness the bi-stable display 230 shows and, on the contrary, if the longer duration of a second voltage is applied, the more brightness the bi-stable display 230 shows. The first voltage and the second voltage are symmetrical voltage with respect to a reference voltage. For one example, provided that the reference voltage is 0V and the first voltage is 5V, the second voltage should be −5V.

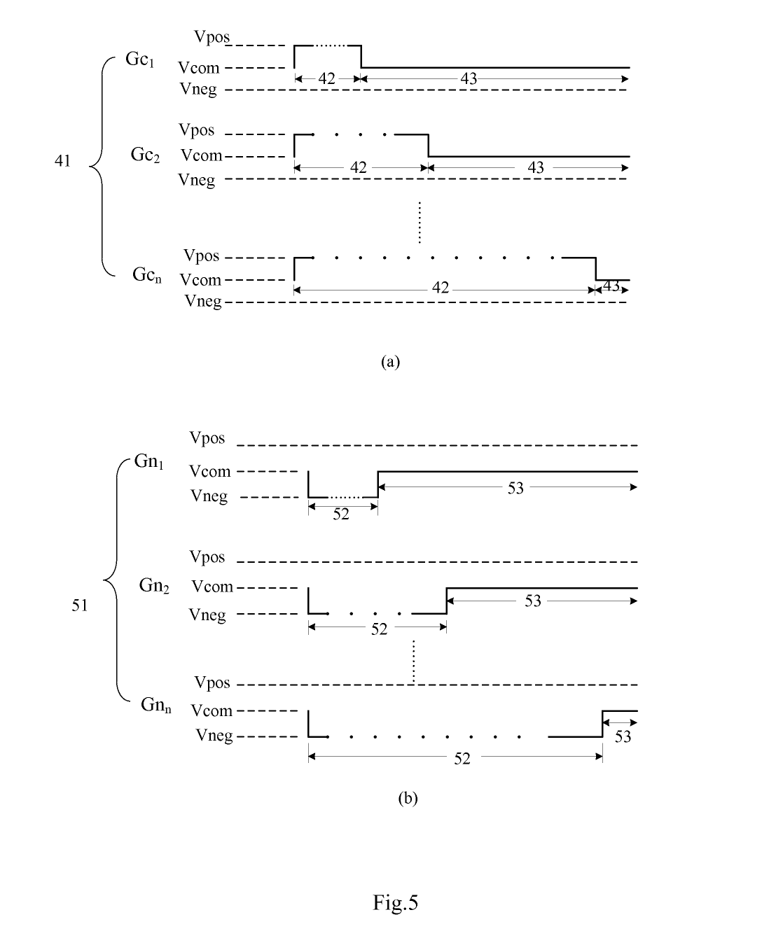

In one embodiment, as shown in FIG. 5, the first and the second voltages are the positive voltage (Vₚₒₛ) and the negative voltage (V_{neg}), respectively, and the displaying LUT output device 222_1 generates displaying control signals 41 to control gray levels of the bi-stable display 230. As shown in FIG. 5 (a), the control signal G_{C1} with the shortest duration of positive state 42 causes the bi-stable display 230 to exhibit the most brightness, while the control signal G_{CN} with the longest duration of positive state 42 causes the bi-stable display 230 to exhibit the most darkness. Accordingly, the duration of the positive state 42 between the shortest and the longest can manipulate the gray level of the bi-stable display 230.

The clearing LUT output device 222_2 generates clearing control signals 51, which act like the inverse signal of displaying control signals 41, to control gray levels of the bi-stable display 230. As shown in FIG. 5 (b), the control signal Gₙ₁ with the shortest duration of negative state 52 causes the bi-stable display 230 to exhibit the most darkness, while the control signal G_{nN} with the longest duration of negative state 52 causes the bi-stable display 230 to exhibit the most brightness. Accordingly, the duration of the positive state 52 between the shortest and the longest can manipulate the gray level of bi-stable display 230. In other words, in order to erase the current frame on the bi-stable display 230, clearing control signals 51 (G_{nx(x=1, 2 . . . n)} generated by the clearing LUT output device 222_2 are similar to the complementary signals of displaying control signals 41 generated by the displaying LUT output device 222_1.

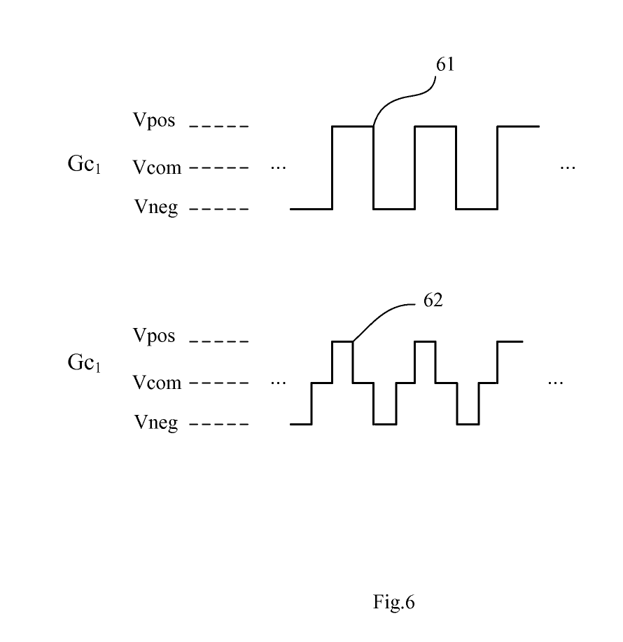

The positive state 42 of displaying control signals 41 and the negative state 52 of and clearing control signals 51 are not limited to be DC voltages. In one embodiment, as shown in FIG. 6, displaying and clearing control signals can behave like the switching waveform_1 61 changing voltages up and down, or the switching waveform_2 62 changing voltages within three levels. However, the equivalent DC voltage of either the switching waveform_1 61 or the switching waveform_2 62 can also control the gray level of a bi-stable display 230.

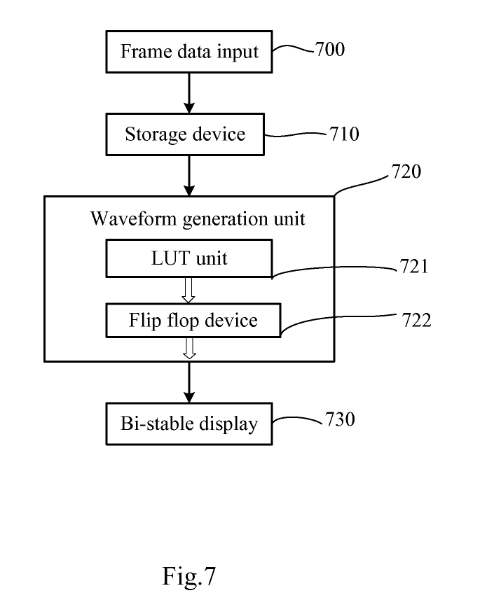

In one embodiment, given that a bi-stable display owns substantially symmetric characteristic, called symmetric bi-stable display, the displaying LUT output device 222_1 and the clearing LUT output device 222_2 are substantially symmetrical and complementary. Therefore, the driving system of the present invention can be modified to the architecture as shown as in FIG. 7. The waveform generation unit 220 as shown as in FIG. 3 can be altered to be the waveform generation unit 720, shown in FIG. 7, which only contains a LUT unit 721 and a flip flop device 722. The flip flop device 722 can generate both displaying control signals and clearing control signals, which of them are substantially symmetrical and complementary, to display or clear a frame on the symmetric bi-stable display 730.

In one embodiment, given that a displaying control signal with a duration of positive state 42, the clearing control signal would have the negative state 52 with the same duration as the positive state 42. In other words, clearing control signals are inverse signals of displaying control signals.

In one embodiment, as shown in FIG. 6, displaying and clearing control signals can behave like the switching waveform_1 61 changing voltages up and down, or the switching waveform_2 62 changing voltages within three levels. However, the equivalent DC voltage of either the switching waveform_1 61 or the switching waveform_2 62 can also control the gray level of a symmetric bi-stable display, and equivalent DC voltages of displaying control signals and clearing control signals are mutually inverse and symmetrical. Furthermore, compared to the waveform generation unit 220 as shown as in FIG. 3, the storage space for storing output conditions in the waveform generation unit 720, shown in FIG. 7, can be reduced to the half.

Although some embodiments of the present invention have been described, it will be understood by those skilled in the art that the present invention should not be limited to the described preferred embodiments. Rather, various changes and modifications can be made within the spirit and scope of the present invention, as defined by the following Claims.

What is claimed is:

1. A driving system for display comprising:
a frame data input unit for inputting a frame data;
a storage device storing the frame data in sequence from the frame data input unit, wherein a capacity of the storage device is reduced to a critical capacity less than a size of storing two frame data;
a waveform generation unit receiving the frame date from the storage device, wherein the waveform generation unit further comprises a look-up table (LUT) selector and a LUT output unit; after receiving the frame data from the storage device, the waveform generation unit, via the LUT selector, informs the LUT output unit of outputting a control signal; and
a display unit receiving the control signal from the LUT output unit and displaying a frame corresponding to the frame data.

2. The driving system for display according to claim 1, wherein the storage device comprises DRAM, SRAM, Flash memory, and storage devices being capable of accessing data successively and/or randomly.

3. The driving system for display according to claim 1, wherein the critical capacity of the storage device is not more than a capacity of storing one frame.

4. The driving system for display according to claim 1, wherein the LUT output unit further comprises a displaying LUT output device and a clearing LUT output device; the displaying LUT output device and the clearing LUT output device are electrically connected to the display unit and output the control signal corresponding to the frame data to the display unit.

5. The driving system for display according to claim 1, wherein the control signal includes DC voltages or switching waveforms with equivalent DC voltages.

6. The driving system for display according to claim 4, wherein the displaying LUT output device sends out a displaying control signal to show a frame corresponding to the frame data on the display unit.

7. The driving system for display according to claim 4, wherein the clearing LUT output device sends out a clearing control signal to clear a frame corresponding to the frame data on the display unit.

8. The driving system for display according to claim 1, wherein the display unit comprises a bi-stable display with gray levels determined by duration of a first voltage or a second voltage, applied on the bi-stable display; the longer duration of the first voltage has, the more darkness of the bi-stable display shows, and the longer duration of the second voltage has, the more brightness of the bi-stable display shows.

9. The driving system for display according to claim 4, wherein in the condition that a frame with N gray levels, the displaying LUT output device only needs to store N displaying output conditions and the clearing LUT output device only needs to store N clearing output conditions.

10. The driving system for display according to claim 4, wherein the control signal includes DC voltages or switching waveforms with equivalent DC voltages.

11. The driving system for display according to claim 8, wherein the first voltage and the second voltage include a DC voltage or a switching waveform with an equivalent DC voltage, and the values of the first voltage and the second voltage are not equivalent.

12. The driving system for display according to claim 1, wherein the waveform generation unit comprises a look-up table (LUT) unit and a flop flip device, and the display unit comprises a symmetric bi-stable display; after receiving the frame date from the storage device, the waveform generation unit, via the LUT unit, informs the flip flop device of outputting a control signal; and the symmetric bi-stable display receives the control signal from the flip flop device and displays a frame corresponding to the frame data.

13. The driving system for display according to claim 12, wherein the control signal include DC voltages or switching waveforms with equivalent DC voltages.

14. The driving system for display according to claim 12, wherein the symmetric bi-stable display substantially has symmetric characteristic so that a displaying control signal and a clearing control signal to show and clear a frame, respectively, on the symmetric bi-stable display are substantially symmetric and complementary.

15. The display driving system according to claim 12, wherein the symmetric bi-stable display with gray levels determined by duration of a first voltage or a second voltage applied on the symmetric bi-stable display.

16. The display driving system according to claim 15, wherein the longer duration of the first voltage has, the more darkness of the symmetric bi-stable display shows, and the longer duration of the second voltage has, the more brightness of the symmetric bi-stable display shows.

17. The display driving system according to claim 14, wherein the displaying control signal and the clearing control signal generated by the flip flop device are substantially symmetrical and complementary.

18. The display driving system according to claim 12, wherein in the condition that a frame with N gray levels, the LUT unit only needs to store N output conditions.

19. A method of driving a display, the method applied on the driving system according to claim 1 comprises:
when the display unit would like to update a new frame, the waveform generation unit first reads the frame data of a current frame from the storage device;
thereupon the waveform generation unit, via the LUT selector, informs the LUT output unit of outputting the control signal to clear the current frame on the display unit;
after reading a new frame data from the frame data input unit, the storage device sends the new frame data to the waveform generation unit;
the LUT selector informs the LUT output unit of sending the control signal to update the new frame on the display unit.

20. A method of driving a display, the method applied on the driving system according to claim 12 comprises:
when the symmetric bi-stable display would like to update a new frame, the waveform generation unit first reads the frame data of a current frame from the storage device;
thereupon the LUT unit informs the flip flop device of outputting the control signal to clear the current frame on the symmetric bi-stable display;
after reading a new frame data from the frame data input unit, the storage device sends the new frame data to the waveform generation unit;
the LUT unit informs the flip flop device of sending the control signal to update the new frame on the symmetric bi-stable display.
